(19) United States
(12) Patent Application Publication
(10) Pub. No.: US 2023/0292127 A1
(43) Pub. Date: Sep. 14, 2023

(54) WIRELESS DEVICE PRIVACY WITHIN WIRELESS MOBILE

(71) Applicant: Invisv Inc., Marina Del Rey, CA (US)

(72) Inventors: Barath Raghavan, Irvine, CA (US); Paul Schmitt, Santa Monica, CA (US)

(21) Appl. No.: 18/182,110

(22) Filed: Mar. 10, 2023

Related U.S. Application Data
(60) Provisional application No. 63/319,637, filed on Mar. 14, 2022.

(51) Int. Cl. H04W 12/08; H04W 12/06; G06F 9/54; H04W 12/72

(52) U.S. Cl. CPC H04W 12/08; G06F 9/547; H04W 12/06; H04W 12/72

(57) ABSTRACT

Systems and methods for providing privacy-preserving mobile connectivity services to a mobile device. In some aspects, the system, based on receiving a request for an authentication token from a mobile device, generates the authentication token for transmission to the mobile device. The authentication token is decoupled from the mobile device requesting the authentication token such that the authentication token cannot be used to identify the mobile device. The system, based on receiving a request for connectivity to a mobile network operator and the authentication token from the mobile device, determines whether the authentication token is valid. The system, based on determining that the authentication token is valid, obtains, from the mobile network operator, an access code for initiating connectivity for the mobile device to the mobile network operator and transmits the access code to the mobile device.

### CROSS REFERENCE TO RELATED APPLICATIONS

This application claims the benefit of priority of U.S. Provisional Pat. Application No. 63/319,637, filed on Mar. 14, 2022, which is hereby incorporated by reference in the present application.

### BACKGROUND

Prior art described the decoupling of authentication and connectivity in mobile networks by means of assigning all mobile devices a single international mobile subscriber identity (IMSI) value and then performing authentication after the connection of the device to the network via an oblivious (anonymous), end-to-end cryptographic protocol from the device to an external authentication server. That is, in this prior art, the device was assigned the same IMSI as all other devices and so the network was unable to determine whether the user was a valid user, and the post-connect authentication protocol was necessary to validate that the user was indeed a valid, paying subscriber so as to fulfill the billing functionality desired by the mobile operator. This contrasted with the existing practice in mobile networks in which a mobile device has a unique IMSI and thus it connects to the network and authenticates at the same time.

Mobile devices have a built-in International Mobile Equipment Identity (IMEI) number that is unique to a device. The IMEI is typically issued by the mobile device manufacturer and identifies both the make and/or model of the device and the specific device itself. The IMEI can be used by some mobile networks to block certain devices from joining the network by querying for the IMEI from the mobile device.

### SUMMARY

In some aspects, systems and methods are described for providing privacy-preserving mobile connectivity services to a mobile device. The system receives, from a mobile device, a request for an authentication token. The mobile device is configured to use the authentication token at a subsequent time to request for connectivity to a mobile network operator. The system, in response to receiving the request for the authentication token, generates, using an authentication token server module, the authentication token for transmission to the mobile device. The authentication token is decoupled from the mobile device requesting the authentication token such that the authentication token cannot be used to identify the mobile device.

At a subsequent time, the system receives, from the mobile device, a request for connectivity to a mobile network operator. The request for connectivity to the mobile network operator includes the authentication token. The system, in response to receiving the request for connectivity to the mobile network operator, determines, using the authentication token server module, whether the authentication token is valid. The system determines whether the authentication token is valid by determining whether a digital signature of the authentication token is valid and whether the authentication token has been used at a prior time.

The system, in response to determining that the authentication token is valid, obtains, from the mobile network operator, via a mobile connectivity application programming interface (API), an access code for initiating connectivity for the mobile device to the mobile network operator. The system transmits, to the mobile device, the access code for initiating connectivity for the mobile device to the mobile network operator.

Various other aspects, features, and advantages of the disclosure will be apparent through the detailed description and the drawings attached hereto. It is also to be understood that both the foregoing general description and the following detailed description are examples, and not restrictive of the scope of the disclosure.

### BRIEF DESCRIPTION OF THE DRAWINGS

FIG. 1 is a block diagram illustrating an example environment in which techniques for mobile privacy are shown. In this example environment, a Mobile Privacy Service Provider is a separate entity or organization that handles mobile privacy functionality for a Mobile Privacy App that resides on or near a mobile device which interacts with a Mobile Operating System on a device. The device then can use a Mobile Network Operator (MNO) or Mobile Virtual Network Operator (MVNO) to connect to the Internet and/or the telephone network. (While the description herein uses the term “mobile device”, the present technology is applicable to all types of mobile devices, including handsets, tablets, laptops, vehicles, etc., as well as with any of various fixed wireless devices.)

FIG. 2 is a block diagram illustrating an overview of an environment in which some implementations of the disclosed technology can operate.

FIG. 3A is a block diagram illustrating components which, in some implementations, can be used in a system employing the disclosed technology. The user of a Mobile Privacy Service can install a Mobile Privacy App on a mobile device. The Mobile Privacy App can, upon payment for service, retrieve authentication tokens from the Mobile Privacy Service Provider. These authentication tokens can be oblivious (anonymous).

FIG. 3A illustrates how a Payment Manager component in the Mobile Privacy App can store the received authentication tokens in an Authentication Token Database in the App. A Connectivity Manager component in the App can then retrieve the authentication tokens and send one or more as appropriate to the Mobile Privacy Service Provider’s Connectivity Orchestrator component, which can verify the authentication token(s) for their authenticity. The Connectivity Orchestrator can then send the Connectivity Manager component in the Mobile Privacy App embedded subscriber identity module (eSIM) code(s) that it had previously retrieved from an MNO’s or MVNO’s eSIM / Mobile Plan API.

The Mobile Privacy App then indicates to an eSIM Manager component that it can initiate an eSIM fetch request from the MNO / MVNO’s subscription manager data preparation (SMDP) / SMDP+ service. The App can then use Mobile Operating System functionality to install the retrieved eSIM.

The Mobile Operating system that manages the device can then proceed to connect to the MNO / MVNO network as normal to obtain normal connectivity to the Internet and/or telephony network(s).

Since the authentication tokens are not linked to the identity of the user and/or their device, neither the Mobile Privacy Service Provider nor the MNO / MVNO learn a correspondence between the user/device/app and a specific eSIM that was retrieved by that user/device/app. This can enable privacy of the user/device from the MNO / MVNO.

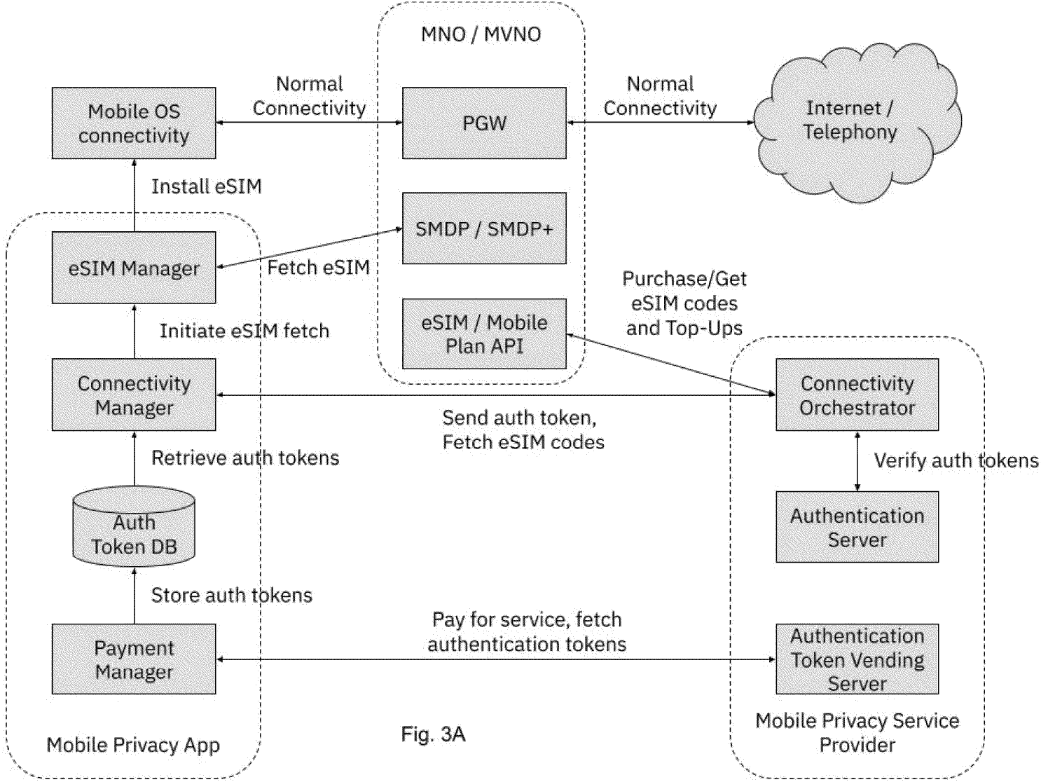

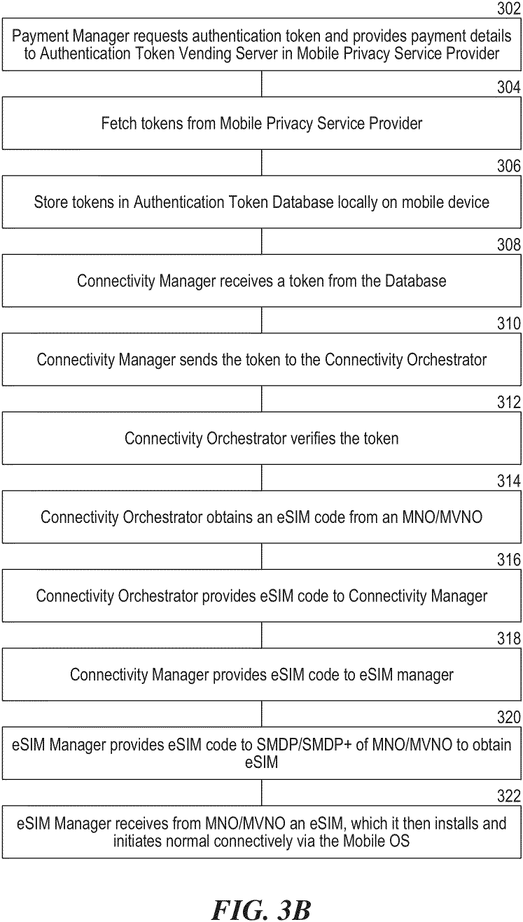

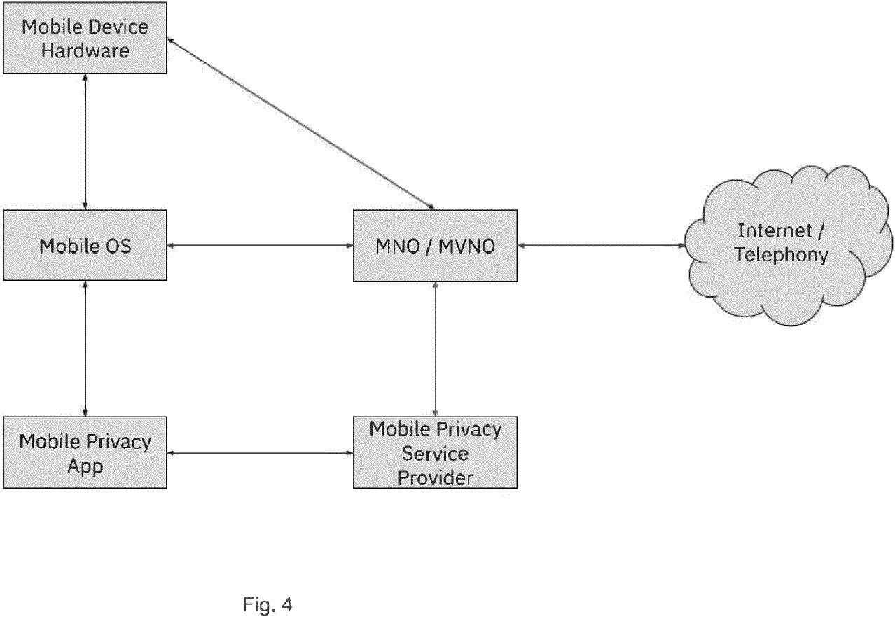

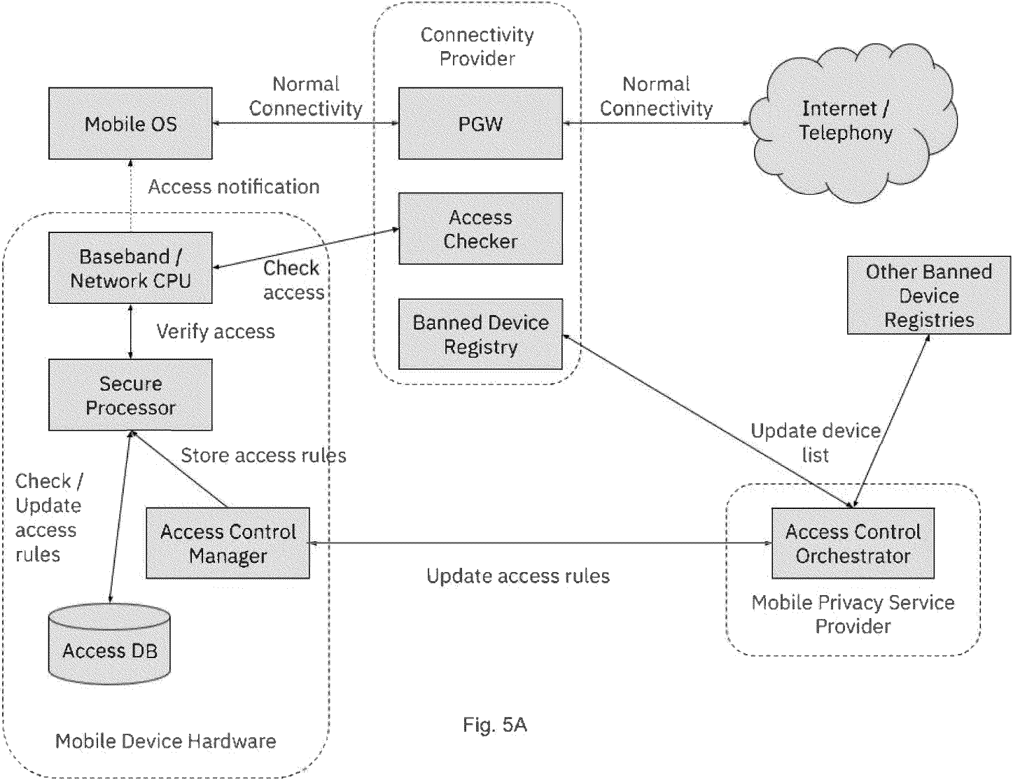

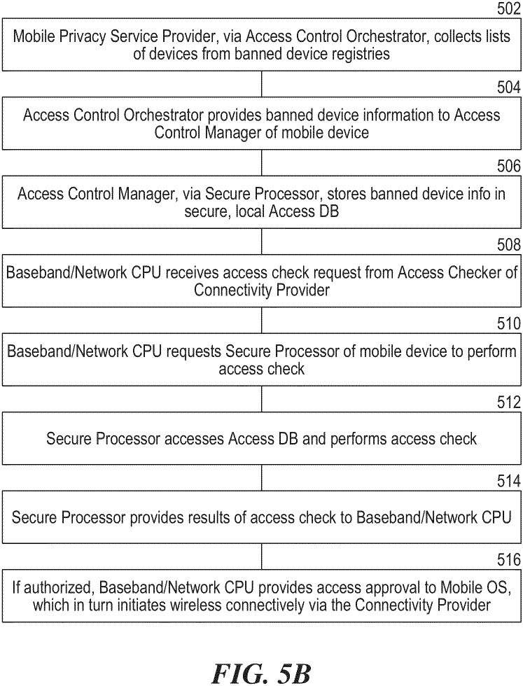

FIG. 3B is a flowchart illustrating functionality of the Mobile Privacy App on the mobile device and its interaction with the Mobile Privacy Service Provider and other blocks of FIG. 3A.

FIG. 4 is a block diagram illustrating an example environment in which techniques for mobile device identifier privacy are shown.

FIG. 5A is a block diagram illustrating components which, in some implementations, can be used in a system employing the disclosed technology for mobile device identifier privacy. The Mobile Device Hardware can include a secure processor that is capable of executing a secure protocol to check an access database (Access DB) that can check whether the device is allowed to access a given network but without revealing the identity of the device itself. This protocol can enable the device to prove to a connectivity provider or other third party that the device is allowed on the network or otherwise is allowed services. The Access Control Manager component, which can reside either in hardware or software on the mobile device, periodically can receive access rule updates from the Mobile Privacy Service Provider or other entity. The Mobile Privacy Service Provider’s Access Control Orchestrator component can get updated lists of banned devices, stolen devices, or other access control rules from one or more registries of banned or otherwise access-limited devices. These registries and lists can use cryptographic techniques to sign the lists to prove their authenticity and/or provide other metadata such as time of creation, geographical origin, governing law and/or national jurisdiction, etc.

A network connectivity provider or other similar entity can query the device via its baseband or network CPU either directly or indirectly via the Mobile Operating System (Mobile OS) in order to verify that the device should be given access to the network. The connectivity provider can verify that the device is allowed to connect, and can potentially verify the authenticity of the access control list obtained from a device registry, the timestamp / date of the list, and other relevant information about the list and type of list used to verify that the device is allowed access. This verification process implemented by the Mobile Device Hardware in the disclosed technology does not reveal the private device identifier itself, and thus can protect the privacy of the device and/or the user who possesses the device.

FIG. 5B is a flowchart illustrating functionality of the Mobile Privacy App on the mobile device and its interaction with the Mobile Privacy Service Provider and other blocks of FIG. 3A.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms even be emphasized below; however, any terminology intended to be interpreted in any restricted manner will be overtly and specifically defined as such in this Detailed Description section.

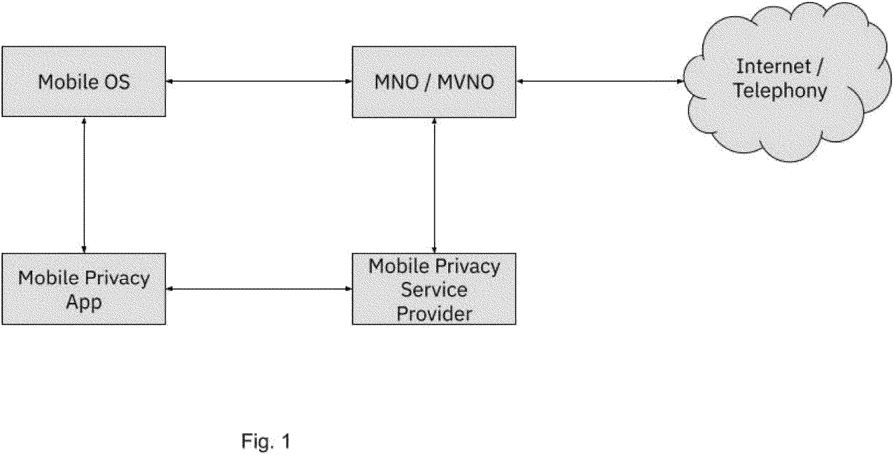

Several implementations of the described technology are discussed below in more detail in reference to the figures. Turning now to the figures, FIG. 1 is a block diagram illustrating an overview of devices on which some implementations of the disclosed technology can operate. The devices can comprise hardware or software components of devices that provide mobile privacy and/or connectivity. The Mobile Privacy Service Provider can be an entity that operates one or more components / devices whose purpose is to enable privacy for users and their mobile devices. The Mobile Privacy Service Provider can interact with a Mobile Network Operator (MNO) and/or a Mobile Virtual Network Operator (MVNO) that are responsible for providing ordinary mobile network services.

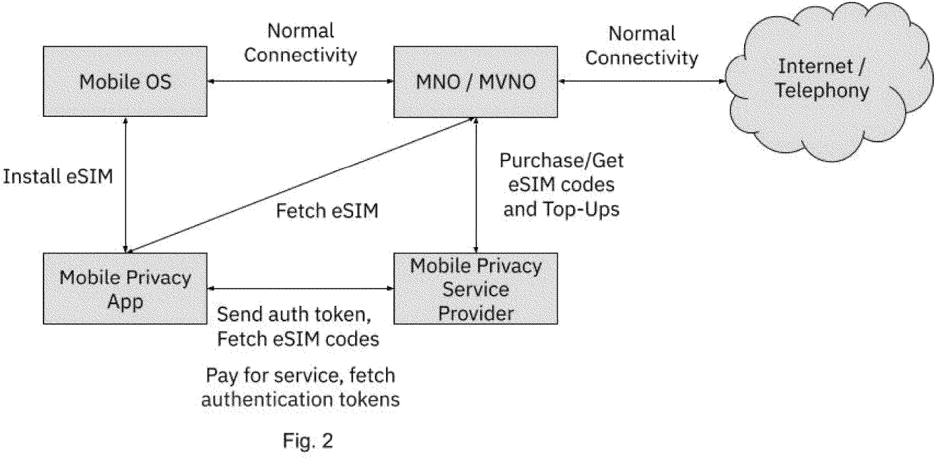

FIG. 2 is a block diagram illustrating an overview of how some implementations of the disclosed technology can operate. The devices can interact in the manner depicted in the figure, wherein the Mobile Privacy Service Provider retrieves information about eSIMs from the MNO or MVNO and then provides this information via a privacy-preserving protocol to the user who is running an app in a mobile device or is otherwise running some code on some device that will eventually convey the eSIM information to a mobile device for use by the user for connecting to a mobile network.

An “eSIM,” as used herein, can be any of a variety of technologies for permitting a wireless device to access a wireless network. The eSIM can be a tamper-resistant hardware device secured in a wireless device, or securely stored code in the device, where the eSIM is or stores data for the mobile device to access a wireless network. For example, as used herein an eSIM can employ an eUICC, which can be a chip soldered into the wireless device itself, and thus is a replacement to a conventional SIM that is stuck into the SIM tray of the device.

An eSIM can also be a partial or fully-software-based implementation that operates similarly to an eUICC. An eSIM installed by a user is analogous to a SIM that is inserted physically into a mobile device by the user to provide new connectivity / service for that user from a new service provider. From a user’s perspective, a traditional eSIM can come in the form of a QR code that they scan to initiate wireless connectivity, where the data from the scanned QR code is sent to the SMDP+ server run by the wireless carrier to fetch the eSIM profile and then install it on the user’s device. The eSIM code described herein can thus be a string of data instead of a QR code to be scanned, so that the code can be used by the app to access the wireless network. (In general an eSIM / eSIM profile, with a typical IMSI, is sent directly from the SMDP+ server to the wireless device through a special encrypted protocol defined by GSMA, shown in FIG. 2 as “fetch eSIM”.) Overall, the present system provides standard eSIM support to authorize a user’s wireless device for connectivity with a wireless network.

FIG. 3A is a block diagram illustrating an overview of how some implementations of the disclosed technology can operate. A new type of entity created as part of the disclosed technology, a Mobile Privacy Service Provider, can engage in a partnership with and/or in a customer relationship with an MNO or MVNO to retrieve access codes for eSIMs (“eSIM codes”). The Mobile Privacy Service Provider can retrieve one or more eSIM codes in a Connectivity Orchestrator component. The Mobile Privacy Service Provider can also accept payment for privacy-preserving mobile services from a Mobile Privacy App that is specific to the disclosed technology. The app can provide payment and/or proof of payment and can be given authentication tokens from the Authentication Token Vending Server, which can use anonymous/oblivious cryptographic authentication tokens.

Since the token fetch process ensures that the identity of the user/device/app is not known to the Mobile Privacy Service Provider, the use of the tokens later can be ensured to be privacy-preserving.

The Mobile Privacy App can store the tokens in an authentication token database from which another app component, the Connectivity Manager, can retrieve them. The Connectivity Manager can use one or more tokens to fetch the eSIM codes from the Connectivity Orchestrator component of the Mobile Privacy Service Provider, which can check that the token(s) are valid using the Authentication Server component. Once verified, the Connectivity Orchestrator can send one or more eSIM codes to the Connectivity Manager, which then can immediately or at a later time initiate the fetch/retrieval of one or more eSIMs via an eSIM Manager component. In some implementations the eSIM Manager can be a separate mobile app or app component, or be part of the mobile operating system. The eSIM Manager can fetch the eSIM from the MNO’s or MVNO’s SMDP or SMDP+ service and then install the eSIM for use by the mobile device, either directly or through interaction with the mobile operating system’s (Mobile OS) eSIM functionality.

Once a new eSIM is installed on the device, the Mobile OS can use the eSIM for ordinary connectivity, connecting to an MNO / MVNO as usual (e.g., via a packet data network gateway (PGW) providing connectivity from the mobile device to external packet data networks by being its point of exit and entry of traffic) and obtaining connectivity to the Internet and/or to a telephone network / telephony services including voice calling, SMS, MMS, etc.

In some implementations there is a single IMSI in the eSIM and in some there are multiple IMSIs in the eSIM. In some implementations the IMSIs in the eSIMs are one-time use only, issued by the MNO / MVNO and used one time by the mobile device. In some implementations the IMSIs in the eSIMs are deterministically selected by the MNO / MVNO and/or Mobile Privacy Service Provider. In some implementations the IMSI(s) is/are selected through some other mechanism that is non-deterministic.

In some implementations the MNO / MVNO and/or Mobile Privacy Service Provider can know the mapping from IMSI(s) to device(s) but is trusted to keep this private. In some implementations the MNO / MVNO and/or Mobile Privacy Service Provider can know the IMSI mapping but discards logs or doesn’t log the IMSI allocation sequence / mapping. In some implementations the MNO / MVNO and/or Mobile Privacy Service Provider delegates to a third party the IMSI allocation and the third party can hold this private or doesn’t log it.

In some implementations a zero-trust mechanism can be used to ensure that no party knows the sequence of random IMSIs and/or which user gets which IMSI. For example, the Mobile Privacy Service Provider can implement its functionality in a hardware-or software-based Trusted Execution Environment (TEE) or Secure Enclave, such as Intel SGX, Amazon Nitro, ARM TrustZone, AMD PSP/SEV, etc. which can ensure that even the Mobile Privacy Service Provider is unaware of the correspondence between IMSIs or other identifiers embedded in or associated with the eSIMs and the users that they are assigned to. As a result, in such an implementation the app or user-controlled device can perform its communication with the Mobile Privacy Service Provider without using a privacy-preserving protocol such as the RSA blind signature-based protocol and can instead communicate directly with the Mobile Privacy Service Provider code that is running in the TEE or Secure Enclave.

In some implementations, the MNO / MVNO and/or Mobile Privacy Service Provider can use a mechanism for secure escrow / long-term storage of the IMSI mapping for the above cases, allowing for (optionally) retrieval upon a court order or other legal proceeding. In some implementations, the IMSI can be stored in a write-only memory on the device that requires physical dismantling of the wireless device to retrieve.

In some implementations, all of the above can be considered with respect to the equivalent 5G or later generation equivalent of the IMSI, such as the SUPI and/or SUCI, and with the 5G or later generation equivalent to other core mobile technologies in this system. That is, all of the above can be considered to apply to protecting the privacy of the SUPI and/or SUCI used by a user.

Turning to FIG. 3B, an example process flow is shown for providing wireless connectively while retaining wireless device privacy. The process flow includes the following steps.

Step 302: The Payment Manager requests authentication token and provides payment details to Authentication Token Vending Server in Mobile Privacy Service Provider. The payment manager can pay through Apple Pay / Google Pay / Stripe / etc. and provide proof of payment to the Mobile Privacy Service Provider. Any payment for the connectivity the user gets would be paid by the provider to the MNO/MVNO. Alternatively, the payment is made directly to the MNO/MVNO through the user’s existing payment system and the proof of payment, through any standard mechanism, is sent to the Mobile Privacy Service Provider.

The token does not include the IMSI or even a time necessarily, but is metadata relating to what the token represents (optionally) plus a random value that is signed/authenticated by the Mobile Privacy Service Provider in such a way that it can verify authenticity but does not know which user has which token.

Step 304: Fetch tokens from Mobile Privacy Service Provider.

Step 306: Store tokens in Authentication Token Database locally on mobile device.

Step 308: Connectivity Manager receives a token from the Database. The Connectivity Manager retrieves a token from the DB when it needs to send one to the Connectivity Orchestrator to get an eSIM -- similar to a “payment” for the eSIM code it’ll get in reply. The token is like a virtual anonymous currency, and a cryptocurrency or cryptocurrency-type data structure can be used, in which case the flow through the payment manager becomes optional because the payment (cryptocurrency transaction) could be handled at this step 4 instead of at the payment manager step.

The Connectivity Manager could do this step automatically, for example once a day it can send a token, get a new eSIM code, and then send it to the eSIM manager to get it fetched and installed to get a new IMSI for the wireless device. It could also be done manually by the user by tapping a button in the app.

The app functionality can be integrated into a wireless service provider’s app rather than it being a third party app. In other words, the functionality of the app described herein can be integrated into the provider app (like the Google Fi app or the like), or provided as an SDK or library. Moreover, the app can have promotions to encourage the user to choose a plan or configuration that uses the privacy functionality and/or promotions to encourage the user to fetch new eSIMs via the flow/code/components described herein.

Step 310: Connectivity Manager sends the token to the Connectivity Orchestrator. In general, the token can include a minimum amount of data needed to permit authentication while preserving user privacy, and thus less data is preferred because there is less identifying information that would violate the user’s privacy.

Step 312: Connectivity Orchestrator verifies the token. The verification can be an RSA blind signature-based scheme, i.e., algorithmic (a cryptographic signature check) plus a database check to see if the token has been spent before. So, the authentication server checks the signature in the token, confirms that it has not been used before, generates an approval message and then adds the token to the spent token list (which is a database, used only by an authentication server, not depicted here). If the signature check fails or the token has been spent before, then the processes rejects it.

Step 314: Connectivity Orchestrator obtains an eSIM code from an MNO/MVNO. The connectivity orchestrator presents credentials of the mobile privacy service provider to the MNO or MVNO, which the MNO/MVNO can use to bill the correct party (e.g., the third party providing the app and other non-MNO/MVNO functionality). This third party can sell a B2C offering as the app while the third party maintains the mobile privacy service provider, or as an account in a database maintained by the third party in the case of a B2B offering to an MNO/MVNO. Thus, the present technology can work in both a B2C model where the mobile privacy service provider is directly providing connectivity to users and is a separate company, as well as in a B2B model where the technology is integrated into an offering of the MNO or MVNO, so in the B2B case the “mobile privacy service provider” in the Figs. is actually running on behalf of the MNO or MVNO that wants to offer the present privacy functionality to their users.

Calls from the connectivity orchestrator to the eSIM / Mobile Plan API can either be synchronous or asynchronous. So, the connectivity orchestrator can pre-fetch some eSIM codes and hold them and then dispense them later to the connectivity manager when requested by the app, or the connectivity orchestrator can do it synchronously/on-demand when requests come in from the app/connectivity manager.

Step 316: Connectivity Orchestrator provides eSIM code to Connectivity Manager.

Step 318: Connectivity Manager provides eSIM code to eSIM manager. The eSIM manager is separate because some mobile OSes have code responsible for eSIM management (within the app, sometimes as part of an SDK or even outside the app but still in user-space), and then eSIM installation is something handled through a special API call to Android or iOS, thus out of the Mobile OS Connectivity stack. Once the wireless device has an eSIM code, the eSIM code can be installed from an app like Airalo (or any other travel eSIM app).

Step 320: eSIM Manager provides eSIM code to SMDP/SMDP+ of MNO/MVNO to obtain eSIM.

Step 322: eSIM Manager receives from MNO/MVNO an eSIM, which it then installs and initiates normal connectivity via the Mobile OS.

Several implementations of the described technology are discussed below in more detail in reference to the figures, regarding mobile device identifier privacy. Turning now to the figures, FIG. 4 is a block diagram illustrating an overview of devices on which some implementations of the disclosed technology for mobile device identifier privacy can operate. The Mobile Device Hardware can provide a secure and private verification check so a connectivity provider such as an MNO / MVNO can verify that the device is not stolen and/or is otherwise allowed to connect to the network, and can perform this verification in a way that the MNO / MVNO does not learn the device identifier of the device in question.

FIG. 5A is a block diagram illustrating an overview of how some implementations of the disclosed technology for mobile device identifier privacy can operate. The Mobile Privacy Service Provider can collect lists of devices from banned device registries. In some implementations this provider can be centralized. In some implementations this provider can be distributed. In some implementations this provider can be decentralized and can use a blockchain or other decentralized technology. The provider maintains a database, list, or other collection of identifiers, access control rules, or other means of differentiating between allowed and disallowed devices. In some implementations this can include fine-grained access control data and/or metadata about devices, and can describe different service levels for different devices, different security policies and/or roles for those devices, etc. In some implementations the provider will pull from various lists of rules or identifiers. In some implementations the registries will push to the provider. In some implementations one or more of the registries will be run by a government entity or on behalf of a government entity for enforcement of civil or criminal law purposes.

The provider can supply this information to mobile devices in a push or pull manner. The mobile device can implement its Access Control Manager in hardware. In some implementations this can be implemented in software. The Access Control Manager can be responsible for synchronizing the list of devices and/or rules from the Access Control Orchestrator. In some implementations this can be done on a time-based frequency, such as daily. In some implementations this can be done upon a software or hardware event, such as when there is a request to check access or when the user performs some action.

The Mobile Device Hardware can implement the Secure Processor or CPU using a special-purpose hardware circuit for implementing one or more security protocols that can check the Access DB in a privacy-preserving manner. In some implementations the Secure Processor can be general purpose hardware that contains a trusted execution environment or secure enclave that can execute any software-based cryptography to check the Access DB in a privacy-preserving manner.

The requests for checking the Access DB can be made through a Baseband CPU or Network CPU that is part of the Mobile Device Hardware. These requests can be made directly from the network provider through a message sent in a mobile-specific protocol or through a message sent using an Internet based protocol such as IP, TCP, HTTP, HTTPS, TLS, or otherwise. In some implementations the message can be sent indirectly to the Baseband CPU or Network CPU via the Mobile Operating System (OS). In some implementations the Baseband or Network CPU can allow the Mobile OS to decide which requests to allow and which to deny. In some implementations the Mobile OS can make its own requests to the Mobile Device Hardware to check rules. In some implementations the Mobile OS can make direct requests, on its own behalf or on behalf of a third-party such as a connectivity provider, application provider, or government agency, to the Secure Processor without interacting with the Baseband or Network CPU.

In some implementations the device has a fixed IMEI number that is produced and/or encoded by the hardware manufacturer or device vendor.

In some implementations the protocol for checking the Access DB is a private set intersection with cardinality protocol in which the Secure Processor executes the protocol to intersect the set containing the true, privately-held IMEI with the Access DB’s deny list, and if the answer is 1 or more then the device was listed as a denied device. In some implementations the protocol for checking the Access DB is software running in a trusted execution environment wherein the software can check the Access DB for the device’s true hardware identifier and return an answer without revealing the true hardware identifier. The Secure Processor cryptographically attests to the Access Checker, that it executed the hardware or software protocol faithfully. In some implementations the Secure Processor is a TEE or Secure Enclave that attests using standard techniques to the Access Checker that it is running and executing code correctly to check the Access DB.

For example, in some implementations, when a user first begins to use their mobile device with this technology, the network first makes a request to the mobile device to perform a privacy-preserving access check protocol such as by checking the Access DB using a secure processor on the mobile device. The mobile device completes the protocol and the network checks whether the device is on the list of banned devices. If the device is on the list of banned devices, the device is not allowed to connect to the network for a fixed period of time, such as one day, after which the device can re-initiate this protocol to be checked again.

In some implementations the protocol for checking the Access DB can be some other Secure Multi-party Computation (SMPC) protocol that ensures privacy of the user’s IMEI while verifying access rights.

In some implementations the protocol for checking the wireless device’s access to the network is implemented in a non-trusted device that is separate from the wireless device using a cryptographic SMPC protocol. In some implementations the protocol for checking the wireless device’s access to the network is implemented in a device separate from the wireless device that is using a TEE or Secure Enclave, and this TEE or Secure Enclave can attest to the code it is running to perform the access control checks.

In some implementations, there can exist one or more other device identifiers other than or in addition to the IMEI, and all of the above can apply to those identifiers as well.

Turning to FIG. 5B, an example process flow is shown for preventing wireless connectivity for banned devices while retaining wireless device privacy. The process flow includes the following steps.

Step 502: Mobile Privacy Service Provider, via Access Control Orchestrator, collects lists of devices from banned device registries. The registries can include IMEls as the primary identifiers that would be banned and thus be on a “deny list” for access control purposes. But any other hardware identifier could also be used, including WiFi MAC address, Bluetooth MAC address, etc.

Step 504: Access Control Orchestrator provides banned device information to Access Control Manager of mobile device.

Step 506: Access Control Manager, via Secure Processor, stores banned device info in secure, local Access DB. The banned device list (e.g., a list of IMEIs to be denied access) can be encrypted and sent to the mobile device’s secure enclave / secure processor to hold securely and perform the privacy-preserving check against that list.

In an alternative embodiment, not shown, the list can remain at the MNO / MVNO / network provider, and they perform a secure protocol that checks data from the mobile device against the list. In another alternative embodiment, the list can be stored at the mobile privacy service provider, and they perform a secure protocol that checks an IMEI from the mobile device against the list, thereby avoiding sending the list to the device or sending the IMEI from the device to the provider.

Step 508: Baseband/Network CPU receives access check request from Access Checker of Connectivity Provider/MNO/MVNO.

Step 510: Baseband/Network CPU requests Secure Processor of mobile device to perform access check.

Step 512: Secure Processor accesses Access DB and performs access check.

Step 514: Secure Processor provides results of access check to Baseband/Network CPU.

Step 516: If authorized, Baseband/Network CPU provides access approval to Mobile OS, which in turn initiates wireless connectively via the Connectivity Provider. As described herein, the mobile device’s information is provided in a manner that’s more privacy preserving than systems/protocols today where, e.g., the device’s SIM currently has a javacard applet on it that communicates to the baseband to obtain the device’s IMEI and sends it in the clear to the network operator. The present system instead ensures that the network operator obtains an appropriate authorization message or result, e.g. just an approval or rejection message regarding whether a device should be prohibited from accessing the network or be banned (e.g. if the device’s IMEI is on the banned list). Notably, the network operator does not learn the mobile device’s IMEI itself.

In an alternative embodiment, access control to the wireless network can be moved to the mobile device itself (either the device’s OS, it’s secure hardware or both), though this alternative would require a change the 3GPP standards.

Several implementations of the disclosed technology are described above in reference to the figures. The computing devices on which the described technology can be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A system for providing privacy-preserving mobile connectivity services to a mobile device, comprising:
one or more processors; and
a non-transitory computer-readable medium storing instructions that, when executed by the one or more processors, cause operations comprising:
receiving, from the mobile device, a request for an authentication token,
wherein the mobile device is configured to use the authentication token at a subsequent time to request for connectivity to a mobile network operator;
in response to receiving the request for the authentication token, generating, using an authentication token server module, the authentication token for transmission to the mobile device,
wherein the authentication token is decoupled from the mobile device requesting the authentication token such that the authentication token cannot be used to identify the mobile device;
at the subsequent time, receiving, from the mobile device, a request for connectivity to a mobile network operator,
wherein the request for connectivity to the mobile network operator includes the authentication token;
in response to receiving the request for connectivity to the mobile network operator, determining, using the authentication token server module, whether the authentication token is valid,
wherein determining whether the authentication token is valid includes determining whether a digital signature of the authentication token is valid and whether the authentication token has been used at a prior time;
in response to determining that the authentication token is valid, obtaining, from the mobile network operator, via a mobile connectivity application programming interface (API), an access code for initiating connectivity for the mobile device to the mobile network operator; and
transmitting, to the mobile device, the access code for initiating connectivity for the mobile device to the mobile network operator.

2. A non-transitory computer-readable medium storing instructions that when executed by one or more processors cause operations comprising:
in response to receiving a request for an authentication token from a mobile device, generating, using an authentication token server module, the authentication token for transmission to the mobile device,
wherein the authentication token is decoupled from the mobile device requesting the authentication token such that the authentication token cannot be used to identify the mobile device;
in response to receiving a request for connectivity to a mobile network operator and the authentication token from the mobile device, determining, using the authentication token server module, whether the authentication token is valid,
wherein determining whether the authentication token is valid includes determining whether a digital signature of the authentication token is valid and whether the authentication token has been used at a prior time; and
in response to determining that the authentication token is valid, obtaining, from the mobile network operator, via a mobile connectivity application programming interface (API), an access code for initiating connectivity for the mobile device to the mobile network operator and transmitting the access code to the mobile device.

3. The non-transitory computer-readable medium of claim 2, wherein the authentication token being decoupled from the mobile device requesting the authentication token comprises the authentication token including the digital signature used to determine whether the authentication token is valid, the digital signature being unrelated to the mobile device transmitting the authentication token.

4. The non-transitory computer-readable medium of claim 2, wherein the authentication token is stored in an authentication token database at the mobile device, wherein the mobile device retrieves the authentication token from the authentication token database prior to generating the request for connectivity to the mobile network operator.

5. The non-transitory computer-readable medium of claim 2, wherein a mobile privacy application being executed on the mobile device generates the request for the authentication token and/or the request for connectivity to the mobile network operator.

6. The non-transitory computer-readable medium of claim 5, wherein the mobile privacy application periodically generates a new request for connectivity to the mobile network operator to obtain a new access code for the mobile device.

7. The non-transitory computer-readable medium of claim 2, wherein the access code includes an embedded subscriber identity module (eSIM) code.

8. The non-transitory computer-readable medium of claim 7, wherein the mobile device transmits the eSIM code to a Subscription Manager Data Preparation (SMDP) service or an SMDP+ service to obtain an eSIM for the mobile device.

9. The non-transitory computer-readable medium of claim 8, wherein the mobile device installs the eSIM via a mobile operating system on the mobile device to initiate connectivity to the mobile network operator.

10. The non-transitory computer-readable medium of claim 9, wherein the eSIM includes one or more international mobile subscriber identity (IMSI) values.

11. The non-transitory computer-readable medium of claim 10, wherein at least one of the one or more IMSI values is for one-time use only.

12. The non-transitory computer-readable medium of claim 10, wherein a zero-trust mechanism is used to decouple an IMSI value from the mobile device such that the IMSI value cannot be used to identify the mobile device.

13. The non-transitory computer-readable medium of claim 2, wherein determining whether the digital signature of the authentication token is valid comprises determining whether the digital signature of the authentication token is valid based on a cryptographic signature scheme or an RSA blind signature-based scheme.

14. The non-transitory computer-readable medium of claim 2, wherein the operations further comprise:
in response to determining that the authentication token is valid, inserting the authentication token into a spent token list.

15. The non-transitory computer-readable medium of claim 14, wherein whether the authentication token has been used at a prior time comprises determining whether the authentication token is included in the spent token list.

16. The non-transitory computer-readable medium of claim 2, wherein the access code for initiating connectivity for the mobile device to the mobile network operator is obtained from the mobile network operator via the mobile connectivity API in a synchronous manner in response to receiving the request for connectivity to the mobile network operator.

17. The non-transitory computer-readable medium of claim 2, wherein the access code for initiating connectivity for the mobile device to the mobile network operator is obtained from the mobile network operator via the mobile connectivity API in an asynchronous manner prior to receiving the request for connectivity to the mobile network operator.

18. The non-transitory computer-readable medium of claim 2, wherein the mobile network operator includes a mobile virtual network operator.

19. The non-transitory computer-readable medium of claim 2, wherein the authentication token includes a cryptocurrency-type data structure.

20. A method for providing privacy-preserving mobile connectivity services to a mobile device, comprising:
based on receiving a request for an authentication token from the mobile device, generating the authentication token for transmission to the mobile device, wherein the authentication token is decoupled from the mobile device requesting the authentication token such that the authentication token cannot be used to identify the mobile device;
based on receiving a request for connectivity to a mobile network operator and the authentication token from the mobile device, determining whether the authentication token is valid; and
based on determining that the authentication token is valid, obtaining, from the mobile network operator, an access code for initiating connectivity for the mobile device to the mobile network operator and transmitting the access code to the mobile device.
